(19) United States
(12) Patent Application Publication
(10) Pub. No.: US 2025/0294276 A1
(43) Pub. Date: Sep. 18, 2025

(54) PORTABLE SPEAKER GROUPING WITH CONTROL FEATURE

(71) Applicant: Bose Corporation, Framingham, MA (US)

(72) Inventors: Douglas Moore Reynolds, Brookline, MA (US); Olivia Rose Wentzell, Ketchum, ID (US); Michael William Elliot, North Grafton, MA (US); Hyun Doug Kim, Somerville, MA (US); Jonathan Hilton Cooper, Newport, RI (US); Douglas Warren Young, Arlington, MA (US)

(21) Appl. No.: 18/605,906

(22) Filed: Mar. 15, 2024

(51) Int. Cl. H04R 1/02

(52) U.S. Cl. CPC H04R 1/02; H04R 2420/07

(57) ABSTRACT

Various implementations include systems and approaches for grouping speakers. In some cases, an audio device includes: a body housing an electro-acoustic transducer; a controller for controlling the electro-acoustic transducer; and an actuatable control feature on the body configured to control audio output from an audio source at the electro-acoustic transducer in a plurality of modes, wherein, in a first of the plurality of modes, the audio output includes a subset of channels of the audio source, output in coordination with at least one additional audio device, and in a second of the plurality of modes, the audio output includes an entirety of the channels of the audio source, output in synchrony with the at least one additional audio device.

### TECHNICAL FIELD

This disclosure generally relates to audio systems. More particularly, the disclosure relates to controlling grouping of speakers such as portable speakers.

### BACKGROUND

Portable speakers such as portable home speakers can enable convenient, spontaneous creation of audio environments in many usage scenarios. However, conventional portable speakers can have shortcomings, particularly in terms of grouping speaker functions and/or coordinating output with additional speakers in a group. For example, adding or removing portable speakers from a speaker group can be cumbersome and/or cause undesired output among speakers in the group. Further, controlling audio output in grouped speakers, as well as grouping such speakers, often requires use of an external device such as a smart device running a software application.

### SUMMARY

All examples and features mentioned below can be combined in any technically possible way.

Various implementations include systems and approaches for grouping speakers. In some cases, an audio device includes: a body housing an electro-acoustic transducer; a controller for controlling the electro-acoustic transducer; and an actuatable control feature on the body configured to control audio output from an audio source at the electro-acoustic transducer in a plurality of modes, wherein, in a first of the plurality of modes, the audio output includes a subset of channels of the audio source, output in coordination with at least one additional audio device, and in a second of the plurality of modes, the audio output includes an entirety of the channels of the audio source, output in synchrony with the at least one additional audio device.

In additional particular aspects, a method includes: receiving a command at an actuatable control feature on an audio device, and controlling audio output from an audio source at the audio device in a plurality of modes, wherein, in a first of the plurality of modes, the audio output includes a subset of channels of the audio source, output in coordination with at least one additional audio device, and in a second of the plurality of modes, the audio output includes an entirety of the channels of the audio source, output in synchrony with the at least one additional audio device.

Implementations may include one of the following features, or any combination thereof.

In some cases, the electro-acoustic transducer includes a plurality of transducers.

In particular cases, the actuatable control feature is one of a plurality of control features with one or more assigned functions. In certain cases, assigned functions (which may also be called, shortcuts) can be pre-assigned, and/or assigned via actuation of the control feature. In some examples, functions can be assigned using a software application (or, app) with a connected device such as a smart device. In further examples, one or more actuatable control feature(s) can have a default assigned function, and can be actuated to perform a control operation without requiring a user to interface with a software application.

In some aspects, in a third of the plurality of modes, the audio output includes the entirety of the channels of the audio source, output independently of the at least one additional audio device. In some examples, a common control feature enables a user to cycle through the plurality of modes.

In particular aspects, the first mode includes a stereo mode.

In certain cases, in the stereo mode, the audio device outputs one of a left channel or a right channel of the audio source.

In particular aspects, the second mode includes a party mode, and the audio output in the second mode is spatially independent of the synchronized output at the at least one additional audio device.

In some implementations, the controller is configured to provide feedback at the audio device about operation in the plurality of modes, where the feedback includes at least one of visual feedback, audible feedback, or haptic feedback.

In certain aspects, the controller is configured to provide a series of voice prompts in response to actuation of the actuatable control feature, the series of voice prompts indicating a distinction between the plurality of modes. In some examples, switching between the plurality of modes is controlled by a hysteresis factor. In some cases, the hysteresis factor can mitigate unwanted switching between the plurality of modes.

In further examples, the controller is configured to receive a secondary actuation such as a hold command to pause or terminate a change between modes. In some examples, the secondary actuation can include an interface or button press or a voice command.

In some cases, in the first mode the series of voice prompts indicate which of the subset of channels of the audio source are associated with the audio device.

In some examples, the voice prompts help to enhance positioning of the audio device. In particular examples, the voice prompts provide feedback (e.g., voice feedback) to the user to adjust a position (e.g., location and/or angle) of the audio device. In some cases, the feedback can include an indication that the audio device should be aligned relative to another device (e.g., aligned left or right in another particular mode such as a stereo mode). In certain additional examples, the feedback can include an indication that the audio device should be moved to a minimum separation from another device (e.g., in a particular mode such as a party mode).

In certain examples, speaker roles are indicated by voice prompts at one or more speakers. For example, in a stereo mode, each speaker can provide a voice prompt (e.g., an audio output such as “Left,” or “Right,”) as an indicator of channel assignment and/or alignment.

In particular cases, in the second mode the series of voice prompts indicate the output is in synchrony with the at least one additional audio device. In some examples, the synchronous output is called a “party mode.”

In some aspects, the controller is further configured, in response to a first actuation of the control feature, to default to the first mode when the at least one additional audio device is acoustically similar to the audio device. In some examples, audio devices are acoustically similar when such devices have the same acoustic package, are of the same type (e.g., make/model), or are acoustically compatible.

In certain examples, the controller is further configured, in response to a first actuation of the control feature, to default to the second mode when the at least one additional audio device is acoustically dissimilar to the audio device.

In particular cases, the controller is further configured to disconnect the audio device and the at least one additional audio device in response to a press-and-hold command at the control feature.

In some aspects, the control feature enables switching between the plurality of operating modes without disconnecting the audio device and the at least one additional audio device.

In certain implementations, in the second mode the audio is output in synchrony with at least two additional audio devices. In some examples, the additional audio devices include two, three, four, or more audio devices in addition to the audio device.

In some cases, the plurality of additional audio devices each include a control feature, and in response to actuation of the control feature at the audio device, the controller is configured to select, among the audio device and the plurality of additional audio devices, a controlling paired device list (PDL) for the audio output.

In certain examples, leader election is used to determine the controlling PDL. In one case, leader election is based on determining which speaker was actuated (e.g., pressed) first, for example, using a countdown clock. In these cases, the audio devices are in distinct clock domains, and a countdown clock is used to determine which device was actuated first.

In further examples, leader election is based on determining whether one of the devices is already connected to a source device (e.g., a phone, a tablet, etc.), and adjusting the PDL cycle (e.g., identity) for a secondary device such as a speaker so that it uses the primary audio device and/or the source device for control of the audio playback.

In some aspects, once the secondary device is determined, the PDL cycle for the secondary device is adjusted to defer to the PDL cycle for primary speaker in view of the source. In certain of these cases, the secondary device loses its identity (e.g., PDL) during the grouped playback and does not get its PDL back until the group is disbanded.

In particular aspects, selecting the controlling PDL is based on at least one of, primacy of actuation of the respective control features among the audio device and the plurality of additional audio devices, or primacy of connection with the audio source.

In some aspects, a PDL for each additional speaker defers to the controlling PDL until an override command is received. In some examples, an override command can enable a user of a second device to reestablish control of the secondary audio device.

In particular examples, the override command in the first mode is distinct from the override command in the second mode.

In some implementations, the at least one additional audio device is selected for control by the audio device based on at least one of, proximity to the audio device or acoustic similarity between the audio device and the at least one additional audio device. In some examples, proximity is determined based on a received signal strength indicator (RSSI).

In certain aspects, the actuatable control feature includes a fixture on the body.

In some examples, the fixture includes a permanent physical feature such as a button or slider. In particular examples, the permanent physical feature is dedicated to the control function.

In particular implementations, the fixture includes at least one of a button, a dial, or a slider. Example buttons can include a press-to-actuate button or a capacitive touch button. In further implementations, the fixture includes a digital user interface (UI) that enables actuation according to implementations herein.

In certain aspects, the fixture includes a visual feedback element for indicating a distinction between operation in the plurality of modes. In some examples, the visual feedback element includes a lighting change and/or change in display of an icon.

In various implementations, the audio device is a portable speaker.

In some cases, the housing includes a carrying strap.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including a plurality of audio devices, according to various disclosed implementations.

FIG. 2 is top view of a portion of an audio device including an interface according to various implementations.

FIG. 3 is side view of the audio device of FIG. 2, further illustrating a carrying strap, according to various implementations.

FIG. 4 is a close-up view of an interface on an audio device according to various implementations.

FIG. 5 is a close-up view of an interface on an audio device according to various additional implementations.

FIG. 6 is a chart illustrating aspects of distinct control modes for an audio device according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that an actuatable control feature on the body of an audio device can be used to control audio output in a plurality of modes. In particular cases, a first mode includes outputting a subset of channels of an audio source, in coordination with at least one additional audio device. In some cases, a second mode includes outputting an entirety of the channels of the audio source, in synchrony with the additional audio device(s).

As noted herein, conventional portable speakers and related approaches for managing audio output from such speakers can fail to account for dynamic usage scenarios. For example, it can be cumbersome to join conventional portable speakers to an existing speaker grouping and/or separate portable speakers from a grouping once joined. Further, conventional portable speakers and related approaches can fail to adapt to movement of the portable speakers within a space occupied by other speakers. Additionally, many conventional approaches for managing speaker grouping rely on a software application running on a separate device, e.g., a smart device. In these conventional approaches, a user is forced to manage speaker grouping by engaging the separate device, launching the software application on the separate device, and actuating grouping functions on the interface at the separate device.

In contrast to conventional approaches and systems, various implementations include approaches for controlling speaker grouping using an actuatable control feature located on a speaker. In particular cases, the actuatable control feature is located on the body and is configured to control audio output from an audio source in a plurality of modes. In some aspects, the actuatable control feature includes feedback about the modes, e.g., the state of one or more modes. In a first of the modes the audio output includes a subset of channels of the audio source, output in coordination with at least one additional audio device. In a second of the modes the audio output includes an entirety of the channels of the audio source, output in synchrony with the at least one additional audio device. The devices and approaches disclosed herein can enable a user to control an audio device in plurality of modes using a control feature on the device body. Such devices and approaches can simplify device controls for users, and improve accessibility to such controls.

Commonly labeled components in the FIGURES are considered to be substantially equivalent components for the purposes of illustration, and redundant discussion of those components is omitted for clarity. Various features of portable speakers are described herein, however, additional features of such speakers may be relevant to the disclosed implementations. Such additional features can be described in U.S. patent application Ser. No. 18/835,997 (“Dynamic Portable Speaker Grouping,” filed Nov. 1, 2023), Ser. No. 18/387,144 (“Audio System Control Device,” filed Nov. 6, 2023), Ser. No. 18/541,359 (“Audio Device with Hidden Connection Point,” filed Dec. 15, 2023), and Ser. No. 18/407,980 (“Audio Device with Accessory Coupler,” filed Jan. 9, 2024), each of which is incorporated by reference in its entirety.

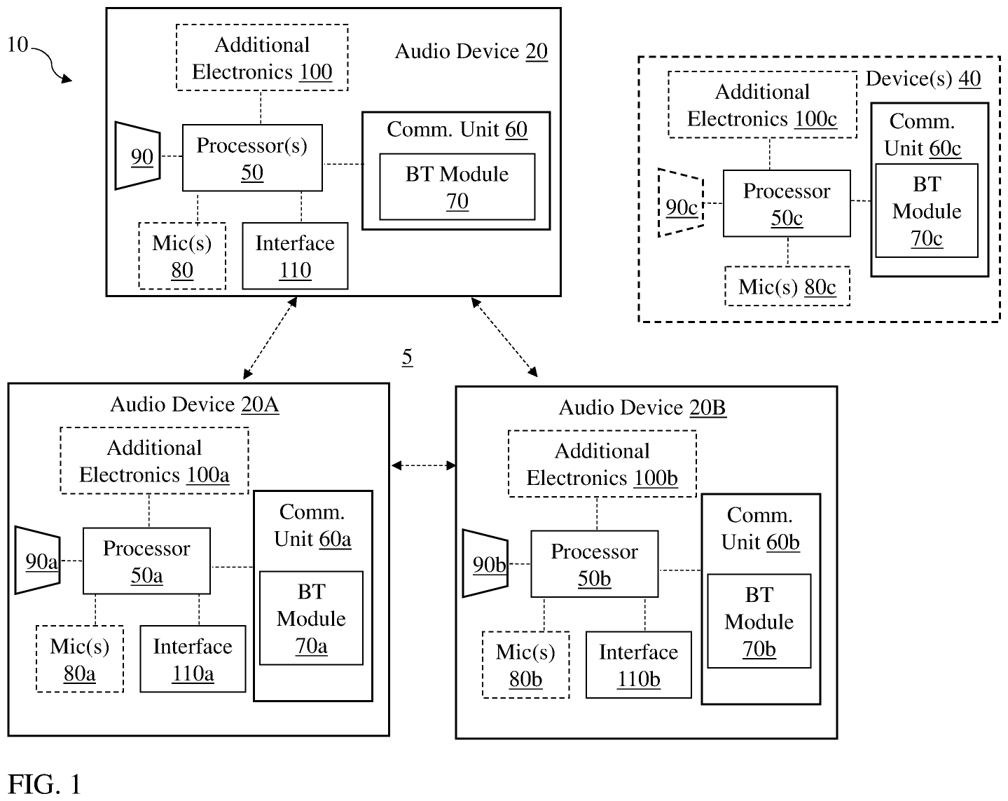

FIG. 1 shows an example of an environment (or, space) 5 including a system 10 with a set of devices according to various implementations. In various implementations, the system 10 is shown including one or more audio devices 20 configured to provide an audio output, e.g., to space 5. In some examples, a plurality of audio devices (e.g., audio devices 20, 20A, 20B, etc.) are located in space 5. As described herein, in various implementations at least one audio device 20 includes a portable loudspeaker such as a portable smart speaker, a portable home speaker, or a portable public address (PA) system. In certain cases, one or more audio devices 20 is configured to coordinate audio output with additional audio devices 20, e.g., in space 5 or between spaces. In certain aspects, the system 10 is located in or around space 5, e.g., an enclosed or partially enclosed room in a home, office, theater, sporting or entertainment venue, religious venue, etc. In some cases, the space 5 has one or more walls and a ceiling. In other cases, the space 5 includes an open-air venue that lacks walls and/or a ceiling.

In one example implementation, another device 40 such as a smart device can be located in the space 5 and can be configured to communicate with the audio devices 20 according to various implementations. In certain examples, device 40 can include a communications device, an audio gateway device, a computing device, etc. In various implementations, device 40 is a personal electronic device such as a smart phone, smart watch, or tablet computing device.

In certain cases, the space 5 includes a plurality of audio devices 20, 20A, 20B, etc., that are capable of being connected with device 40 and/or one another. In further implementations, one or more of the audio devices 20 is configured to connect with the device 40, e.g., for charging. In certain cases, the plurality of audio devices 20, 20A, 20B, are either, of a same make and a same model, or differing in at least one of make or model. Two or more devices (e.g., audio devices 20) can communicate with one another using any communications protocol or approach described herein.

One or more of the audio devices 20 can include a portable speaker, such as a portable home speaker. It is understood that a “portable speaker” or a “portable home speaker” as described herein can refer to any of a number of speakers that are configured for wired and/or wireless operation, and are configured to change location. In certain cases, such speakers are labeled as “portable,” but this is not necessary in all implementations. Further, portable speakers and portable home speakers can be configured to charge in a dock, wirelessly charge, and/or remain connected to an external power source such as an outlet or additional device while outputting audio. Non-limiting examples of portable speakers provided by Bose Corporation (Framingham, MA, USA) can include the Bose Portable Smart Speaker, the Bose SoundLink Flex, the Bose SoundLink Micro, the Bose SoundLink Mini II, and/or the Bose SoundLink Revolve II (product names truncated for brevity). One or more audio devices described herein may be described as “fixed,” meaning that the audio device is designed to output audio in a static location or is configured to be mounted or otherwise fixed in a location. Certain examples of fixed speakers include wall or ceiling-mounted speakers, recessed speakers, speakers that form part of a surround sound unit in a home or other room entertainment system, and/or fixed speakers in a conference room, office, indoor/outdoor space, etc.

In certain cases, the audio device(s) 20 each include one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In addition to processor(s) 50, 50a, 50b, the audio devices 20 can also include one or more microphones 80 (e.g., a microphone array), and a transducer 90 (e.g., an electro-acoustic transducer) for providing an audio output, e.g., in space 5. Further, the audio devices 20, can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). Certain of the above-noted components depicted in FIG. 1 are optional, and are displayed in phantom.

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

The audio devices 20 can be configured to output audio from an audio source. In some cases, the audio source can include an audio gateway device such as device 40. In additional cases, the audio device 20 can be configured to output audio from an audio source via a network, cellular, and/or cloud-based connection, e.g., via a streaming music service, an internet radio station, a stored audio file library, etc. In various implementations, the audio devices 20 can be referred to as “smart” devices that have network and/or cellular connectivity, and in certain cases, operate or otherwise execute virtual personal assistant (VPA) functions.

In particular cases, the processor(s) 50 may provide, for example, for coordination of other components of the audio device(s) 20 and/or device 40, such as control of acoustic properties for audio playback at the audio device(s) 20. In various implementations, processor(s) 50 in audio device 20 include a grouping control module which can include software and/or hardware for performing control processes described herein. For example, processor(s) 50 can include a grouping control module in the form of a software stack having instructions for controlling functions in outputting audio across one or more audio devices 20 according to any implementation described herein.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, communication unit 60 is particularly suited to communicate with other communication units 60 in audio devices 20 and/or additional device(s) such as smart devices (e.g., smartphones, tablets, smart watches) via Bluetooth. In still further implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF) and/or a hard-wired connection, e.g., between any two or more devices.

In certain example implementations, additional devices 40 such as smart phones, smart watches, tablets, etc. in space 5 can include similar components (e.g., a processor 50 and communications unit 60) as the audio device(s) 20. Further, those additional devices 40 can include additional components that may not necessarily be present at the audio device 30. Additional device(s) 40 can be configured to communicate with any device described herein. Further, in certain cases, distinct audio devices 20A, 20B can include distinct speakers in the space 5, and in particular cases, can include one or more portable speakers in the space 5.

Also shown in FIG. 1, one or more audio devices 20 can include an interface 110 on its body, which as described herein can include an actuatable control feature. In certain cases, the interface 110 can include a touch screen, button, dial, slider, etc., that is configured to control output from an audio source at transducer(s) 90 in a plurality of modes. In various implementations, the interface 110 is physically located on the body of the audio device 20, e.g., on a top surface, side surface, or any other surface of the audio device 20.

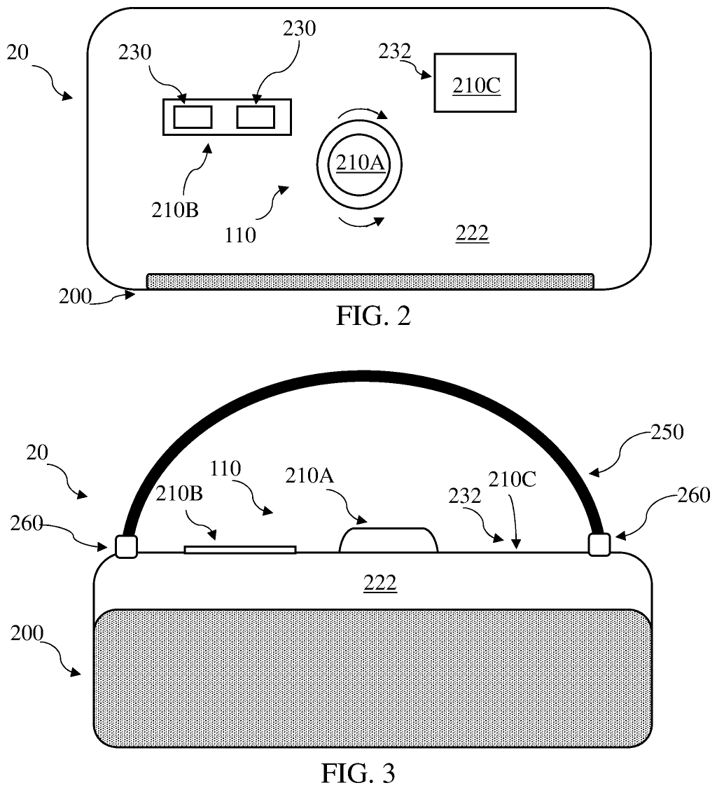

FIG. 2 shows a top view of an example interface 110 on an audio device 20 according to various implementations. FIG. 3 shows a side view of the audio device 20 including the interface 110. The audio device 20 is shown including a speaker grille 200 in this example, but various form factors of audio device can benefit from the disclosed interface features and related control functions. As such, the depictions in FIGS. 2 and 3 are merely illustrative. FIGS. 2 and 3 show various non-limiting examples of distinct types of actuatable control feature 210 according to various implementations. Three distinct types of actuatable control feature 210A, 210B, 210C are shown as non-limiting examples, and it is understood that a given audio device 20 may include only one of those control features 210. In a first example, the actuatable control feature 210A includes a physical interface control, for example, a three-dimensional (3D), tangible control feature. In certain cases, the actuatable control feature 210A has an approximately circular shape, and in more particular cases, can resemble a dial or knob. In various implementations, the actuatable control feature 210A protrudes from a housing 222 of the control device 20, and is located on one or more faces of the housing 222. In certain cases, the actuatable control feature 210A is configured to receive an input via rotation (e.g., in one or two directions), compression, touch or tap command, or a combination of such inputs. In still further implementations, an actuatable control feature 210B includes a button 230 such as a hardware button that is physically and/or visually defined on the housing 222. In certain cases, the actuatable control feature 210B is one of several buttons 230 on the housing 222 enabling control of various device functions, e.g., power on/off, connection with another device (e.g., via Bluetooth), input control (e.g., via an auxiliary input), and/or playback control such as pause/play/skip and volume controls. The actuatable control feature 210B can include a physical button and/or a capacitive touch button. In still further implementations, the actuatable control feature 210C is part of a touch interface 232 such as a capacitive touch interface. In such examples, the actuatable control feature 210C is displayed on a touch interface or screen can be part of a capacitive touch surface with a defined border or shape, e.g., a square, ring, dial, or knob.

As noted herein, actuatable control features 210 can be part of a permanent, fixed feature on the housing 222 in certain cases. In additional cases, the actuatable control feature 210 is integrated in a user interface such as a dynamic display on the housing 222. In particular examples, the actuatable control feature 210 is dedicated to the control function, e.g., the function of coordinating audio output with one or more audio devices 20.

As noted herein, the audio device 20 can include a portable audio device in various implementations. In such cases, in addition to interface features illustrated in FIGS. 2 and 3, the audio device 20 can further include a carrying strap 250, which can be coupled with the housing 222 via one or more mounts 260 (FIG. 3). The carrying strap 250 can allow a user to move and/or reposition the audio device 20 between spaces, or within a space (e.g., space 5, FIG. 1).

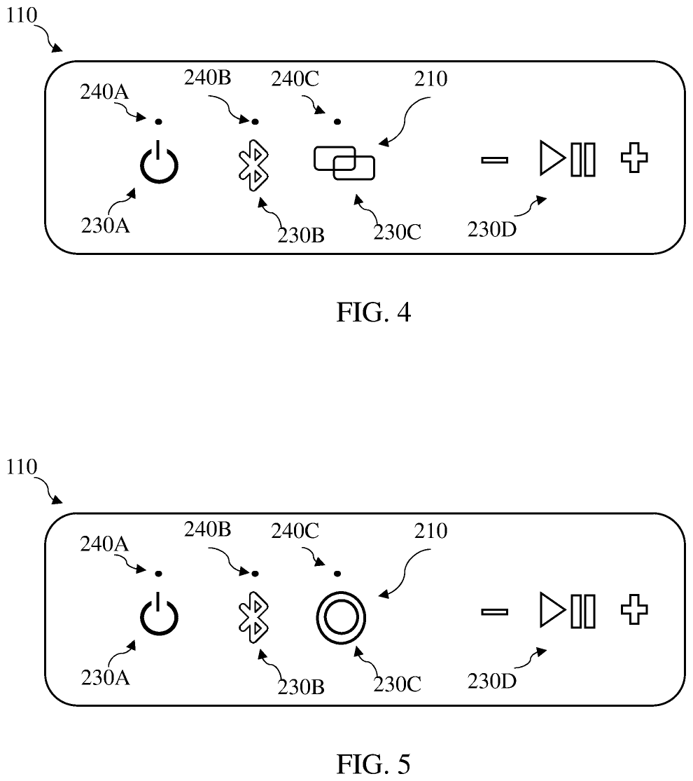

FIG. 4 shows a close-up view of a particular example of an actuatable control feature 210 on an interface 110 of an audio device. In certain cases, the actuatable control feature 210 in FIG. 4 is similar to actuatable control feature 210B in FIGS. 2 and 3. In this implementation, a plurality of buttons (e.g., physical hardware buttons, capacitive touch buttons, and/or displayed buttons) 230 are illustrated on the interface 110. In certain cases, the buttons 230 are shown with associated visual feedback elements (e.g., status indicators) 240, which in some cases can indicate that a function associated with the button 230 is active, and/or that an activity is taking place relative to the button function. In one example, a power button 230A, a wireless connection button 230B (e.g., Bluetooth connection button), an actuatable control feature 230C, and playback control buttons 230D are shown. In various implementations, the actuatable control feature 230C enables control of audio output at the audio device 20 (and in some cases, additional audio devices) in a plurality of modes. In particular examples, the actuatable control feature 230C includes a linking button or feature, and as described herein, can enable functions and/or shortcuts in controlling audio output. Further, corresponding status indicators 240A,B,C are shown for certain buttons 230A,B,C. Status indicators 240 can include multi-function indicators, which can be configured to change one or more visual characteristics to indicate status, e.g., illumination on/off, flashing light, accent features such as a border or secondary line, etc. In this example, the status indicator 240C for actuatable control feature 230C is shown illuminated, e.g., to indicate an activity is taking place relative to the control feature (e.g., an attempt to coordinate playback with at least one additional audio device), or that the control feature is controlling output at the audio device 20 according to one of the modes. In some cases, the status indicator 240C is actuated by controlling a light such as a light emitting diode (LED), e.g., a white or other colored LED. Other multi-function indicators are possible in optional embodiments, e.g., illumination changes, color differentiation, selective bordering, etc.

In various implementations, the actuatable control feature 210 is assigned a plurality of functions and/or shortcuts that enable a user to control audio output with a single user interface command or a command at a single interface feature such as the actuatable control feature 210. In some cases, the actuatable control feature 210 is assigned to a function and/or shortcut using an interface such as an interface at device(s) 40 or another device used during setup of the audio device 20. In particular cases, the function(s) and/or shortcut(s) can be pre-assigned to the actuatable control feature 210 via the interface, such that during subsequent uses of the actuatable control feature 210 the user need not interface with another device external to the audio device 20. In some examples, functions and/or shortcuts are assigned to the actuatable control feature 210 by default, such that a user may not need to interface with an external device to actuate desired control functions. In various implementations, functions and/or shortcuts assigned to the actuatable control feature 210 can be updated and/or modified via a software application on a connected device such as device 40 at any time.

In a particular example, as illustrated in FIG. 5, display of an actuatable control feature 210 can be updated based on a function assigned to that control feature 210. In this example, the actuatable control feature (e.g., button 230C) has an appearance that is correlated with a shortcut function assigned to that feature 210. In certain cases, display of button 230C can be configured to change based on an assigned function, e.g., to have a first (e.g., default) display mode with a first visual appearance and a second display mode with a second visual appearance. In the example depicted in FIGS. 4 and 5, button 230C is configured to visually change (e.g., from overlapping rounded rectangles to concentric circles) in response to a shortcut being assigned to the button 230C. In particular cases, visual display changes can be implemented by changes in backlighting (e.g., LED lighting) and/or changes in a digital display. In some cases, once the shortcut is removed or another triggering event occurs (e.g., resetting the audio device 20 to factory settings or clearing settings), the first visual appearance of a feature 210 (e.g., button 230C) is restored.

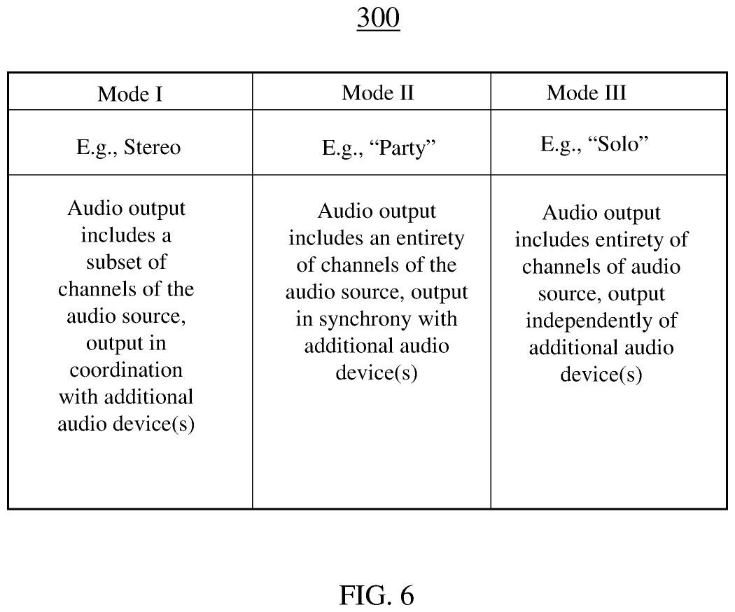

As described herein, the processor 50 at the audio device 20 is configured to control aspects of audio being played at the audio device(s) 20 according to one or more modes as controlled by the actuatable control feature 210. FIG. 6 is an example schematic depiction of a control chart 300 illustrating simplified control parameters for the audio device 20 according to distinct modes and actions at the actuatable control feature 210. With reference to FIGS. 1-6, in particular cases, the processor 50 is configured to operate in at least two distinct modes to control aspects of audio being played at audio device(s) 20. In certain cases, entry into a mode and/or switching between modes is controlled by actuation of the actuatable control feature 210. In a first mode (I): the processor 50 at audio device 20 provides audio output including a subset of channels of an audio source, output in coordination with one or more additional audio devices 20. Using the example of space 5 in FIG. 1, in the first mode (I) the processor 50 provides audio output at transducer(s) 90 at audio device that includes a subset of channels of an audio source (e.g., a music track or stream, podcast, entertainment audio file, etc.) and coordinates output of a distinct subset of channels of the audio source with another audio device 20A (and in certain cases, further audio devices, e.g., audio device 20B). It is understood that the distinct subsets of channels can include overlapping channels, but that the distinct subsets differ in at least one portion of the channels assigned to each device 20, 20A. In certain examples, the first mode (I) includes a stereo mode, for example, where the audio device 20 outputs a left or right channel of the audio source and audio device 20A outputs the other of the left or right channel of the audio source. In some of these examples, both audio devices 20, 20A output a portion of a center channel. In further implementations, the first mode (I) can include a surround sound mode or object-based audio mode where three or more audio devices, e.g., 20, 20A, 20B can be used to provide audio output from the audio source. In such cases, each audio device 20, 20A, 20B outputs a distinct subset of channels of the audio source, e.g., where audio device 20A outputs left channel (L) audio, audio device 20B outputs right channel (R) audio, and audio device 20 outputs a center channel (C), low frequency audio (e.g., as a sub-woofer), or one or more height channels of audio (e.g., in an object-based system).

In particular cases, assignment of subsets of channels is spatially dependent. For example, assignment of subsets of channels to distinct audio devices 20 is based at least in part on a known location and/or known relative location of the audio devices 20 in space 5, e.g., based on detected proximity, orientation, and/or location. In certain cases, the processor 50 is configured to detect a location of the audio device 20 and/or additional audio devices 20A, 20B and assign subsets of channels based on the known location(s). For example, the processor 50 can be configured to use known location assignment data such as naming conventions for the audio devices 20, known docking locations of the audio devices 20 (e.g., proximate a wall location), and/or known orientation data about the audio device 20, e.g., based on an audio device being a forward-firing audio device.

In particular cases, the processor 50 is configured to operate in a second mode (II) based on (e.g., initiated by) user input, e.g., at the actuatable control feature 210. For example, the user input to initiate the second mode can include at least one of: pushing the actuatable control feature 210, pushing and holding the actuatable control feature 210, or pushing a separate button (or an interface 230 interaction) on the audio device 20. In certain aspects, the actuatable control feature 210 is configured to depress to enable pushing and/or pushing and holding, and in some cases, provides tactile, visual, and/or audible feedback. In various particular implementations, when operating in the first mode (I), user input is required to initiate the second mode (II) or any additional mode.

As noted herein, the second mode (II) is different from the first mode, and enables control of at least one distinct aspect of audio played at the audio device(s) 20. In various implementations, the processor 50 is configured in the second mode (II), to output audio at transducer(s) 90 at audio device 20 including an entirety of channels of the audio source, which are output in synchrony with at least one additional audio device 20A, 20B, etc. In certain example cases, the processor 50 is configured to instruct processor 50a to coordinate audio output at audio device 20A in synchrony with audio output at audio device 20B. In certain cases, the second mode (II) is a “party” mode. In some of these examples, the audio output at audio device 20 in the second mode (II) is spatially independent of the synchronized output at the additional audio devices 20A, 20B, etc. That is, regardless of an orientation of the audio devices 20, proximity of audio devices 20, and/or location of audio devices 20, in the second mode (II) each audio device 20 is configured to output an entirety of the channels of the audio source in synchrony with one or more other audio devices 20. In a particular example, in the second mode (II), three or more audio devices (e.g., audio devices 20, 20A, 20B, etc.) are configured to output an entirety of the channels of the audio source in synchrony.

With continuing reference to FIG. 1 and FIG. 6, in particular cases, the processor 50 is configured to operate in a third mode (III) based on (e.g., initiated by) user input, e.g., at the actuatable control feature 210. In some examples, the third mode (III) includes providing audio output at audio device 20 of an entirety of the channels of the audio source, independently of the additional audio device(s) 20A, 20B, etc. In these cases, the audio device 20 acts as a stand-alone speaker without regard for audio output at additional audio device(s) 20A, 20B, etc.

In particular implementations, the distinct modes (e.g., modes (I), (II), and (III)) can be accessed successively, and in some cases, cyclically, via actuation at the actuatable control feature 210. For example, a single type of actuation such as a button press, press-and-hold, tap, rotate, slide, etc., can be used to progress through distinct modes, e.g., beginning with one of modes (I), (II), or (III). In certain additional aspects, initiating one or more modes can be performed with distinct inputs to the actuatable control feature 210. For example, selecting a first mode (I) can be performed with a first input to actuatable control feature 210, selecting a second mode (II) can be performed with a second input to actuatable control feature 210, and selecting a third mode (III) can be performed with a third input to actuatable control feature 210. Examples of distinct inputs can include button press, interface press, button tap, interface tap, dial or knob turn (in one or both directions), dial or knob press, slider translation, slider press, etc., Further, inputs can include multi-factor actuation of the actuatable control feature 210. For example, multi-factor actuation can include a double-press of the actuatable control feature 210, a double-tap of the actuatable control feature 210, a press-and-turn of the actuatable control feature 210, etc.

In particular implementations, the distinct modes (e.g., modes (I), (II), and (III)) can be accessed without disconnecting the audio devices 20. For example, in various implementations the actuatable control feature 210 at audio device 20 enables switching between modes (e.g., (I), (II), (III)) without disconnecting the connection between audio device 20 and additional audio device(s) 20A, 20B, etc., In certain of these cases, the audio devices 20 are wirelessly connected (e.g., via BT, Wi-Fi, RF, Zigbee, etc.) and are configured to remain connected during switches between modes as actuated by the actuatable control feature 210.

In certain additional implementations, audio devices 20 can be disconnected by a command received at the actuatable control feature 210. For example, with reference to FIG. 1, audio device 20 and audio device 20A and/or audio device 20B can be disconnected in response to a multi-factor actuation at the actuatable control feature 210. In a particular example, the processor 50 at audio device 20 is configured to disconnect the audio device 20 from audio device 20A and/or audio device 20B in response to a press-and-hold command at the actuatable control feature 210. Other multi-factor actuation approaches can also be used to disconnect audio devices 20. In still further implementations, the devices 20 can be disbanded such that they exit coordinated output modes (e.g., mode (I) or mode (II)) in response to actuation at a distinct interface or button from the actuatable control feature 210. For example, referring to FIG. 4, the processor 50 can be configured to exit modes (I) or (II) in response to actuation of a power button 230A at the interface 110 while output is occurring according to modes (I) or (II). In certain cases, a press-and-hold command at the power button 230A can cause the processor 50 to exit mode (I) or mode (II).

In various additional implementations, the processor 50 at audio device 20, as well as processors 50 at additional audio devices 20 can be configured to provide feedback about operation in the plurality of modes (e.g., modes (I), (II), (III)). For example, the processor 50 can be configured to provide feedback including at least one of visual feedback, audible feedback, or haptic feedback. Visual feedback can be provided via the interface 110, e.g., via visual feedback elements 240 such as status indicators (FIG. 4), such as with illumination, flashing lights, blinking lights, etc. Tactile (and/or haptic) feedback can be provided by vibrating the audio device 20 in certain cases, e.g., triggering a vibrational pattern at the transducer 90 and/or in additional electronics 100 such as a piezoelectric device. Further, tactile or haptic feedback can be provided by a click, notch, or pushback in adjustment of the actuatable control feature 210. Audible feedback can include an audible click or a chime played at a transducer 90 when actuating the actuatable control feature 210, and/or voice prompts providing contextual information about actuation of the control feature 210.

In certain cases, the type of feedback differs based on mode. For example, feedback can vary based on mode, such that different feedback in the first (I) and second (II) modes can help a user differentiate in which mode they are operating. This differential feedback can be beneficial, e.g., where distinct types of actuation of control feature 210 can cause entry into distinct modes.

In these cases, the processor 50 triggers the feedback to indicate changes in mode and/or indicate a current state in a mode. Audible feedback can be coordinated by the processor 50 at one or more audio devices 20, e.g., via audio output at transducer(s) 90. In particular cases, audible feedback can be used to guide a user through connecting devices (e.g., audio devices), entering and exiting modes (e.g., modes (I), (II), (III)), and disconnecting devices.

In certain aspects, the processor 50 is configured to provide a series of voice prompts in response to actuation of the actuatable control feature 210. For example, when entering the first mode (I), the processor 50 can be configured to initiate a voice prompt (via transducer(s) 90) such as “Stereo Mode”, “Stereo Pair”, or “Stereo Group.” In certain cases, when entering the first mode (I), the processor 50 can initiate a voice prompt at all audio devices 20 that are part of the coordinated audio group. For example, each audio device 20, 20A, 20B in the stereo group can output a voice prompt such as, “Stereo Mode,” or “Stereo Group.” As noted herein, the series of voice prompts can indicate a distinction between the plurality of modes (e.g., modes (I), (II), (III)). In some examples, switching between the plurality of modes is controlled by a hysteresis factor. In some cases, the hysteresis factor can mitigate unwanted switching between the plurality of modes. For example, the processor 50 can receive a command to switch between modes, e.g., via actuatable control feature 210, and prior to switching the mode, applies a hysteresis factor (or, delay) of approximately several seconds to mitigate unwanted switching between modes. In some cases, the processor 50 initiates a voice prompt indicating that the switching between modes is occurring, and applies the hysteresis factor after the voice prompt, and prior to switching. In certain of these examples, the processor 50 is configured to receive a secondary actuation such as a hold command to pause or terminate a change between modes. In some examples, the secondary actuation can include an interface or button press (e.g., via actuatable control feature 210 or another button 230), or a voice command (e.g., “stop” or “stop transition”), such as detected by a virtual personal assistant (VPA) via microphone(s) 80. In some cases, in the first mode (I) the series of voice prompts indicate which of the subset of channels of the audio source are associated with the audio device 20. For example, along with or after the voice prompt indicating the mode (e.g., mode (I)), the processor 50 at each audio device 20 can indicate the subset of channels of the audio source that are associated with the audio device 20, e.g., “Left-Center”, “Right-Center”, “Height”. In certain examples, speaker roles are indicated by voice prompts at one or more audio devices 20. For example, in a stereo mode (e.g., mode (I)), each audio device 20 can provide a voice prompt (e.g., an audio output such as “Left,” or “Right,”) as an indicator of channel assignment and/or alignment.

In some non-limiting examples, the voice prompts help to enhance positioning of the audio device. In particular examples, the voice prompts provide feedback (e.g., voice feedback) to the user to adjust a position (e.g., location and/or angle) of the audio device, e.g., “Move speaker left”, “Rotate speaker”, “Reposition speaker.” In some cases, the feedback can include an indication that the audio device should be moved to a minimum separation from another device (e.g., in a particular mode such as a party mode), or aligned relative to another device (e.g., aligned left or right in another particular mode such as a stereo mode), e.g., “Move speakers closer together”, “Move speakers farther apart.”

In particular cases, in the second mode (mode (II)) the series of voice prompts indicate the output at audio device 20 is in synchrony with at least one additional audio device 20A (and/or 20B). In some examples, as noted herein, the synchronous output is called a “party mode”, and the audio device 20 can output a voice prompt indicating as much, e.g., “Party Mode”, or “Synced Output.”

As noted herein, while various modes (e.g., first (I), second (II), and third (III) modes) are described as enabling control of particular aspects of audio output, it is understood that any of the aspects of audio output described with reference to one mode can be controlled in other modes, and vice versa.

In various additional implementations, the processor 50 is configured to use information about device type to control audio output modes. For example, the processor 50 is configured to use information about a known type of the audio devices 20 to control audio output modes. In certain examples, the processor 50 at a first audio device 20 detects information about the device type of one or more additional connected audio devices, e.g., audio device 20A. In certain cases, the device type is indicated by a device identifier, e.g., managed in a paired device list (PDL) or recognized device list. In further cases, audio devices 20A, 20B, etc., broadcast device type information with one or more communication signals that are detected by the first audio device 20. In any case, the device type information can include characteristics of the audio device(s) 20 such as make/model, acoustic package, acoustic compatibility, audio output characteristics, etc. In some aspects, the processor 50 is configured, in response to a first actuation of the actuatable control feature 210, to default to the first mode (I) when the additional audio device 20A is acoustically similar to the audio device 20. In certain examples, the processor 50 is further configured, in response to a first actuation of the actuatable control feature 210, to default to the second mode (II) when the additional audio device 20A is acoustically dissimilar to the audio device 20. In some examples, audio devices 20 are acoustically similar when such devices have the same acoustic package, are of the same type (e.g., make/model), or are acoustically compatible.

In some implementations, the audio device(s) 20A, 20B, etc. are selected for control by the audio device 20 based on proximity to the audio device 20 and/or acoustic similarity between the audio device 20 and the additional audio device(s) 20A, 20B. In some examples, proximity is determined based on a received signal strength indicator (RSSI). In a particular example, the audio device 20 selects one or more additional audio devices 20A, 20B based on satisfying a threshold proximity, e.g., within X meters, as indicated by RSSI.

Various additional control scenarios can be used according to particular implementations, certain of which can be beneficial for determining which audio device 20 in a group controls aspects of other audio devices 20. For example, in scenarios where a plurality of audio devices 20 (e.g., in space 5) include an actuatable control feature 210, various implementations can aid in controlling potential conflicts between audio sources, paired devices, etc. In one example, each of the audio devices 20, 20A, 20B includes an actuatable control feature 210, and in response to actuation of the control feature 210 at audio device 20, the processor 50 is configured to select, among the audio device 20 and the plurality of additional audio devices 20A, 20B, a controlling paired device list (PDL) for the audio output. In certain examples, leader election is used to determine the controlling PDL. In some examples, leader election is based on determining which audio device 20 was actuated (e.g., pressed) first, for example, using a countdown clock. In these cases, the audio devices 20 may be in distinct clock domains, and a countdown clock is used to determine which device was actuated first.

In another case, leader election is based on determining whether one of the audio devices 20 is already connected to a source device (e.g., a phone, a tablet, etc., such as device 40, FIG. 1), and adjusting the PDL cycle (e.g., identity) for a secondary device such as another audio device 20B so that the secondary device (e.g., audio device 20B) uses the primary audio device 20 and/or the source device (e.g., device 40) for control of the audio playback. In some aspects, once the secondary device (e.g., audio device 20B) is determined, the PDL cycle for the secondary device (e.g., audio device 20B) is adjusted to defer to the PDL cycle for primary audio device 20 in view of the source (e.g., device 40). In certain of these cases, the secondary device (e.g., audio device 20B) loses its identity (e.g., PDL) during the grouped playback and does not get its PDL back until the group is disbanded. In particular aspects, selecting the controlling PDL is based on at least one of, primacy of actuation of the respective control features 210 among the audio device 20 and the plurality of additional audio devices 20A, 20B, or primacy of connection with the audio source (e.g., device 40). In some aspects, a PDL for each additional audio device (e.g., audio device 20A, 20B) defers to the controlling PDL (e.g., from audio device 20) until an override command is received. In some examples, an override command can enable a user of a second audio device 20B to reestablish control of the secondary audio device 20B. In particular examples, the override command in the first mode (I) is distinct from the override command in the second mode (II).

In particular cases, adjusting the mode of the audio output at audio devices 20 can be performed without interrupting the audio being played on the audio device(s) 20. In certain cases, adjusting the mode of audio output is performed while maintaining the volume of the audio playback at one or more audio devices 20, continuing playback of the audio at audio devices 20, or ducking the audio output at audio device(s) 20 in or out.

In any case, the approaches described according to various implementations have the technical effect of enhancing audio control across a plurality of audio devices in an environment. In various implementations, a user can beneficially control audio output in a plurality of modes using an actuatable control feature at one or more audio devices. The actuatable control feature on the devices according to various implementations can provide an efficient, effective means to adjust the aspects of the audio played at the audio device(s) in a space. In certain cases, the actuatable control feature provides a single interface for multi-modal adjustment, streamlining the user experience when compared with conventional approaches and systems. In various implementations, the audio devices provide feedback about the audio modes to enhance the user experience.

Various wireless connection scenarios are described herein. It is understood that any number of wireless connection and/or communication protocols can be used to couple devices in a space, e.g., space 5 (FIG. 1). Examples of wireless connection scenarios and triggers for connecting wireless devices are described in further detail in U.S. patent application Ser. No. 17/714,253 (filed Apr. 4, 2022) and Ser. No. 17/314,270 (filed May 7, 2021), each of which is hereby incorporated by reference in its entirety). Pairing of devices can be performed via any wireless approach described herein (e.g., wireless pairing based on Wi-Fi, RF, BT and/or BLE), and/or via a hard-wired pairing approach such as a setup pairing via a hard-wired connection such as a variation of Universal Serial Bus (USB), High Definition Multimedia Interface (HDMI), etc.

It is further understood that any RF protocol could be used to communicate between devices according to implementations, including Bluetooth, Wi-Fi, or other proprietary or non-proprietary protocols. In implementations that utilize Bluetooth LE Audio, a unicast topology could be used for a one-to-one connection between speakers and/or devices in space 5. In some implementations, an LE Audio broadcast topology (such as Broadcast Audio) could be used to transmit one or more sets of audio data to multiple sets of speakers.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations. Further, although certain embodiments are described above as not requiring manual intervention to initiate pairing, in some embodiments manual intervention may be required to complete the pairing (e.g., “Are you sure?” presented to a user of the source/host device), for instance to provide further security aspects to the approach.

In some implementations, the host-based elements of the approach are implemented in a software module (e.g., an “App”) that is downloaded and installed on the source/host (e.g., a “smartphone”), in order to provide the controlled audio output aspects according to the approaches described above. In particular cases, functions such as audio controls for a group of audio devices can be controlled by a centralized interface command, e.g., a command at an interface on one of the audio devices, e.g., audio device(s) 20, 20A, 20B, etc. In certain cases, the centralized interface command can include a command at a single interface.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

A number of implementations have been described. Nevertheless, it will be understood that additional modifications may be made without departing from the scope of the inventive concepts described herein, and, accordingly, other embodiments are within the scope of the following claims.

We claim:

1. An audio device, comprising:
a body housing an electro-acoustic transducer;
a controller for controlling the electro-acoustic transducer; and
an actuatable control feature on the body configured to control audio output from an audio source at the electro-acoustic transducer in a plurality of modes,
wherein,
in a first of the plurality of modes, the audio output includes a subset of channels of the audio source, output in coordination with at least one additional audio device, and
in a second of the plurality of modes, the audio output includes an entirety of the channels of the audio source, output in synchrony with the at least one additional audio device.

2. The audio device of claim 1, wherein in a third of the plurality of modes, the audio output includes the entirety of the channels of the audio source, output independently of the at least one additional audio device.

3. The audio device of claim 1, wherein the first mode includes a stereo mode, wherein in the stereo mode, the audio device outputs one of a left channel or a right channel of the audio source.

4. The audio device of claim 1, wherein the second mode includes a party mode, and wherein the audio output in the second mode is spatially independent of the synchronized output at the at least one additional audio device.

5. The audio device of claim 1, wherein the controller is configured to provide feedback at the audio device about operation in the plurality of modes, wherein the feedback includes at least one of visual feedback, audible feedback, or haptic feedback.

6. The audio device of claim 1, wherein the controller is configured to provide a series of voice prompts in response to actuation of the actuatable control feature, the series of voice prompts indicating a distinction between the plurality of modes,
wherein in the first mode the series of voice prompts indicate which of the subset of channels of the audio source are associated with the audio device, and
wherein in the second mode the series of voice prompts indicate the output is in synchrony with the at least one additional audio device.

7. The audio device of claim 1, wherein the controller is further configured, in response to a first actuation of the control feature, to default to the first mode when the at least one additional audio device is acoustically similar to the audio device.

8. The audio device of claim 1, wherein the controller is further configured, in response to a first actuation of the control feature, to default to the second mode when the at least one additional audio device is acoustically dissimilar to the audio device.

9. The audio device of claim 1, wherein the controller is further configured to disconnect the audio device and the at least one additional audio device in response to a press-and-hold command at the control feature.

10. The audio device of claim 1, wherein the control feature enables switching between the plurality of operating modes without disconnecting the audio device and the at least one additional audio device.

11. The audio device of claim 1, wherein in the second mode the audio is output in synchrony with at least two additional audio devices.

12. The audio device of claim 1, wherein the plurality of additional audio devices each include a control feature, and in response to actuation of the control feature at the audio device,
the controller is configured to select, among the audio device and the plurality of additional audio devices, a controlling paired device list (PDL) for the audio output,
wherein selecting the controlling PDL is based on at least one of,
primacy of actuation of the respective control features among the audio device and the plurality of additional audio devices, or
primacy of connection with the audio source,
wherein a PDL for each additional speaker defers to the controlling PDL until an override command is received, and
wherein the override command in the first mode is distinct from the override command in the second mode.

13. The audio device of claim 1, wherein the at least one additional audio device is selected for control by the audio device based on at least one of,
proximity to the audio device or acoustic similarity between the audio device and the at least one additional audio device.

14. The audio device of claim 1, wherein the actuatable control feature includes a fixture on the body, wherein the fixture includes at least one of a button, a dial, or a slider, and wherein the fixture includes a visual feedback element for indicating a distinction between operation in the plurality of modes.

15. A portable speaker comprising the audio device of claim 1, wherein the housing includes a carrying strap.

16. A method, comprising:
receiving a command at an actuatable control feature on an audio device, and
controlling audio output from an audio source at the audio device in a plurality of modes, wherein,
in a first of the plurality of modes, the audio output includes a subset of channels of the audio source, output in coordination with at least one additional audio device, and
in a second of the plurality of modes, the audio output includes an entirety of the channels of the audio source, output in synchrony with the at least one additional audio device.

17. The method of claim 16, wherein in a third of the plurality of modes, the audio output includes the entirety of the channels of the audio source, output independently of the at least one additional audio device.

18. The method of claim 16, wherein,
the first mode includes a stereo mode, and wherein in the stereo mode, the audio device outputs one of a left channel or a right channel of the audio source, and
the second mode includes a party mode, and wherein the audio output in the second mode is spatially independent of the synchronized output at the at least one additional audio device.

19. The method of claim 16, further comprising at least one of,
providing feedback at the audio device about operation in the plurality of modes, wherein the feedback includes at least one of visual feedback, audible feedback, or haptic feedback,
providing a series of voice prompts in response to actuation of the actuatable control feature, the series of voice prompts indicating a distinction between the plurality of modes, or
disconnecting the audio device and the at least one additional audio device in response to a press-and-hold command at the control feature.

20. The method of claim 16, further comprising, in response to a first actuation of the control feature, either,
a) defaulting to the first mode when the at least one additional audio device is acoustically similar to the audio device, or
b) defaulting to the second mode when the at least one additional audio device is acoustically dissimilar to the audio device.
